(19) United States
(12) Patent Application Publication
(10) Pub. No.: US 2002/0026486 A1
(43) Pub. Date: Feb. 28, 2002

(54) Individually delivering system

(76) Inventor: Hiroshiye Yabe, Tokyo (JP)

Correspondence Address: BIRCH STEWART KOLASCH & BIRCH, PO BOX 747, FALLS CHURCH, VA, 22040-0747, US

(21) Appl. No.: 09/918,649

(22) Filed: Aug. 1, 2001

(30) Foreign Application Priority Data
Aug. 25, 2000 (JP) 2000-255416
Nov. 10, 2000 (JP) 2000-343325

(51) Int. Cl. G06F 15/16

(52) U.S. Cl. 709/206

(57) ABSTRACT

Here is disclosed an individually delivering system in which a terminal of each recipient is connected to a host computer via wireless- or wire-telecommunication network, said system comprising a recipient identifying device adapted to identify a recipient on the basis of the recipient's personal data at least including the recipient's mail address and name, a name exchanging device adapted to exchange the recipient's name for a temporary name accompanying text or graphic matter previously stored in a recorder, and a delivery device adapted for individually delivering the text or the graphic matter into which the recipient's name has been introduced by said name exchanging device to the recipient's mail address at time or times predetermined by said recipient identifying device.

### TECHNICAL BACKGROUND

The present invention relates to a system for individually delivering various information such as text and graphic matter to recipient via telecommunication network such as Internet, in any case, accompanied with recipient's name.

The system is well known which periodically deliver business liaison correspondence, text of a serial novel or graphic matter to recipient via communication network such as Internet.

However, such delivery system of well-known art has been a simple system adapted to one-way deliver common information to all recipients. Particularly delivery of the serial novel which has already been started, some of the recipients must read this serial novel from the second or later chapter. In addition, the system of prior art has been of so-called closed type because the recipients cannot influence upon or participate in the content of this serial novel.

In view of the problems as have been described above, it is a principal object of the present invention to provide a system adapted for individually delivering appropriate and timely information to each recipient.

### DISCLOSURE OF THE INVENTION

The object set forth above is achieved, according to the present invention, by an individually delivering system using telecommunication network such as internet in a manner as will be described hereinafter.

Specifically, the present invention relates to a system in which a terminal of each recipient is connected to a host computer via wireless- or wire-telecommunication network, said system comprising a recipient identifying device adapted to identify a recipient on the basis of the recipient's personal data at least including the recipient's mail address and name, a name exchanging device adapted to exchange the recipient's name for a temporary name accompanying text or graphic matter previously stored in a recorder, and a delivery device adapted for individually delivering the text or the graphic matter into which the recipient's name has been introduced by said name exchanging device to the recipient's mail address at time or times predetermined by said recipient identifying device.

The text delivered by the delivery device to the recipient's mail address may be character data or speech data.

The graphic matter delivered by the delivery device to the recipient's mail address may be still image data or moving image data.

The time at which the recipient's personal data was received by the recipient identifying device may be recorded together with said personal data to assist the delivery to be made with good timing.

The text accompanied with the temporary name stored in the recorder may be, for example, one chapter of serial novel comprising approximately 10 chapters each composed of several hundred characters and delivered every day to each recipient.

In the case of serial novel, delivery of each chapter may be accompanied with choices regarding a development in the next chapter. Upon reception from the recipient, the content to be delivered on the next day may be adjusted by appropriate choice from the texts accompanied with a temporary name stored in the recorder to establish an open system allowing for active participation of the recipient.

Another example of the text accompanied with the recipient's temporary name stored in the recorder is a non-serial metrical composition containing the respective characters of the temporary name and delivered to the recipient, for example, once for every month to emphasize an effect of the content.

An example of graphic matter accompanied with a temporary name stored in the recorder is the graphic matter containing said temporary name as components of this graphic matter and delivered to the recipient, for example, once every month to emphasize an effect of the text contained in this graphic matter.

The personal data of the recipient may include also items such as the recipient's attributes and memorial days for this recipient to improve an individuality of the delivery.

The text accompanied with a temporary name may have various contents such as liaison matter for business, educational content according to a predetermined program, psychological content for encouragement and formal content of congratulation or condolence, depending on the particular purpose of transmission.

The name exchanging device may be operatively associated with the recipient identifying device to deliver text or graphic matter which is different for every recipient and for every delivery to achieve a high individuality of the delivery system.

The recipient's personal data may include the date and hour on which the text or the graphic matter is to be received by the recipient so that the delivering device may operate on said date and hour to meet convenience for both the deliverer and the recipient.

### BRIEF DESCRIPTION OF THE DRAWINGS

FIG. 1 is a block diagram illustrating important parts of the system according to the invention;

FIG. 2 is a block diagram illustrating an embodiment of delivery of serial novel;

FIG. 3 shows an example of delivered text of serial novel;

FIG. 4 shows example of delivered metrical compositions;

FIG. 5 shows example of delivered graphic matter;

FIG. 6 is a block diagram illustrating important parts of another embodiment of the system according to the invention; and

FIGS. 7(A)(B) shows example of delivered messages.

Reference numerals used in the drawings are identified as follow: 10: recipient's name; 11: characters constituting the recipient's name; 12: array of characters including the recipient's name; 20: text accompanied with recipient's name; 30: text accompanied with recipient's temporary name; 31: temporary name.

### PREFERRED EMBODIMENTS

Details of the invention will be more fully understood from the description of preferred embodiments given hereunder in reference with the accompanying drawings.

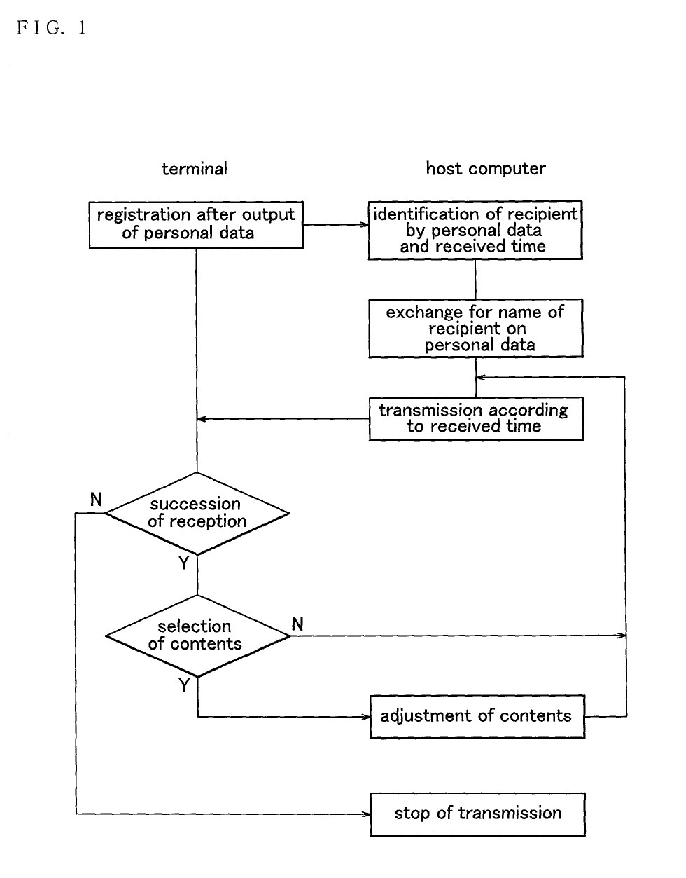

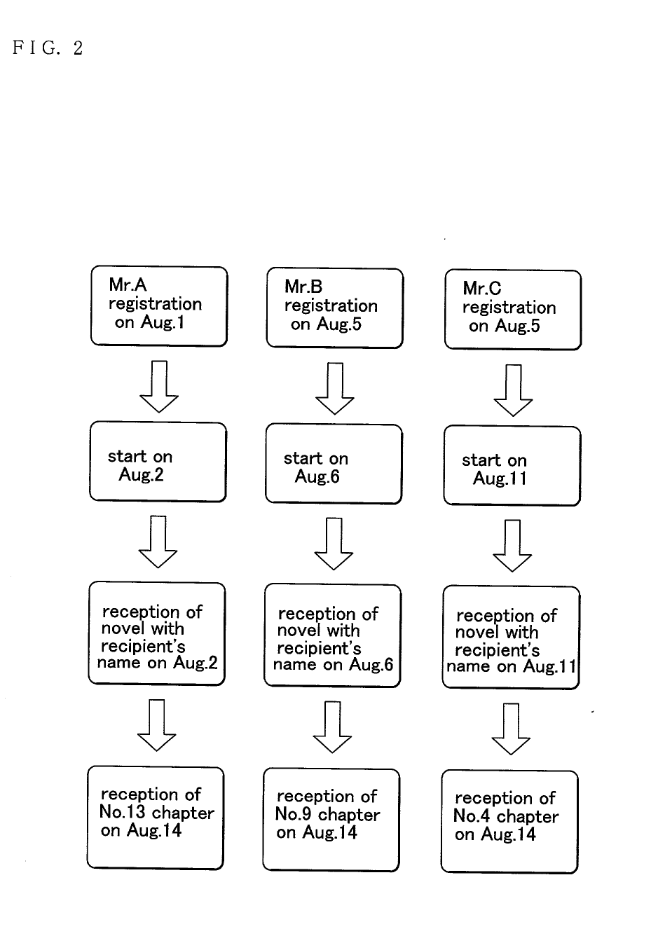

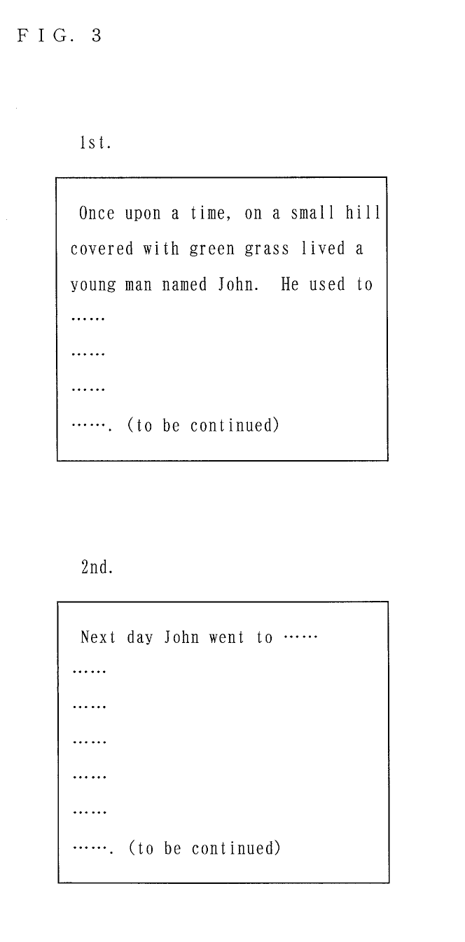

FIG. 1 is a block diagram illustrating important parts of the system according to the invention, FIG. 2 is a block diagram illustrating a manner in which serial novel is delivered and FIG. 3 shows an example of delivered text.

Terminal such as portable telephone used by recipient is provided with input/output means for characters or graphic matters and communication device and connected to host computer via wireless- or wire-telecommunication network such as Internet.

To register use of the system, recipient transmits data including mail address for reception of delivery, recipient' name to be introduced into delivered matter, and, if necessary, personal data such as gender and age from his or her terminal to host computer.

The host computer receives and registers the personal data transmitted from the terminal and recipient identifying device identifies the recipient on the basis of the received personal data and the time at which said personal data was received. Content of the registration is then transmitted back from the host computer to the recipient and the registration is acknowledged.

Thereupon, name exchanging device in the host computer exchanges the recipient name for a temporary name found in the text with this temporary name stored in recorder.

FIG. 3 exemplarily shows the text with the temporary name stored in the recorder which is one chapter of serial novel comprising approximately 10 chapters each composed of several hundred characters. In this example, the recipient name (10) “Watanabe Bin” is exchanged for the temporary name.

Content of the novel to be delivered is selected taking account of the personal data such as gender and age. It is also possible for the recipient to select a desired content of the novel to be delivered at the time of registration. In stead of the novel, teaching materials edited so as to be learned step by step may be also selected as the object to be delivered.

The serial novel accompanied with the recipient name which is selected and composed in this manner is successively delivered to the recipient one chapter for every day at a predetermined time, for example, at noon.

The delivery is individually made to respective recipients at the time based on the time at which the recipient identifying device received the personal data for respective recipients. More specifically, Mr. A and Mr. B are individually delivered with the novel from its chapter 1 at days following the respective registration dates as exemplarily shown in FIG. 2.

Successive delivery of the novel to each recipient one chapter for every day can be controlled by increasing the identifyer assigned to this recipient by one for every delivery and recording the chapter number to be delivered on next day.

As in the case of Mr. C in FIG. 2, it is possible for the recipient to shift the day on which the delivery starts or to request that the delivery should be made on alternate days.

The delivery shall be continued unless the host computer receives from the recipient a message requesting that the delivery should be suspended.

In the case of serial novel, delivery of each chapter may be accompanied with choices regarding a development in the next chapter. Upon reception from the recipient, the content to be delivered on the next day may be adjusted by appropriate choice from the texts accompanied with a temporary name stored in the recorder to establish an open system allowing for active participation of the recipient.

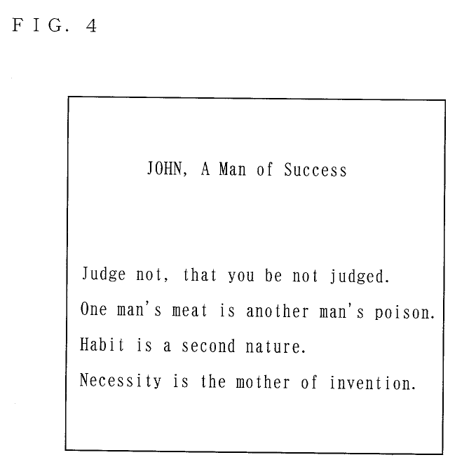

FIG. 4 shows an example of the delivered text in the form of metrical composition.

It is also possible to convert the text accompanied with the recipient's temporary name stored in the recorder to a metrical composition containing the respective characters of the temporary name and to deliver this periodically.

In this example shown in FIG. 4, the recipient's name (10) “JOHN” for the temporary name. The recipient's name is disintegrated into characters (11) “J”, “o”, “H” and “N” and words “Judge”, “One”, “Habit” and “Necessity” containing said characters, respectively. Four sentences containing these words, respectively, are combined into one complete metrical composition which will be delivered to the recipient, for example, once for every month.

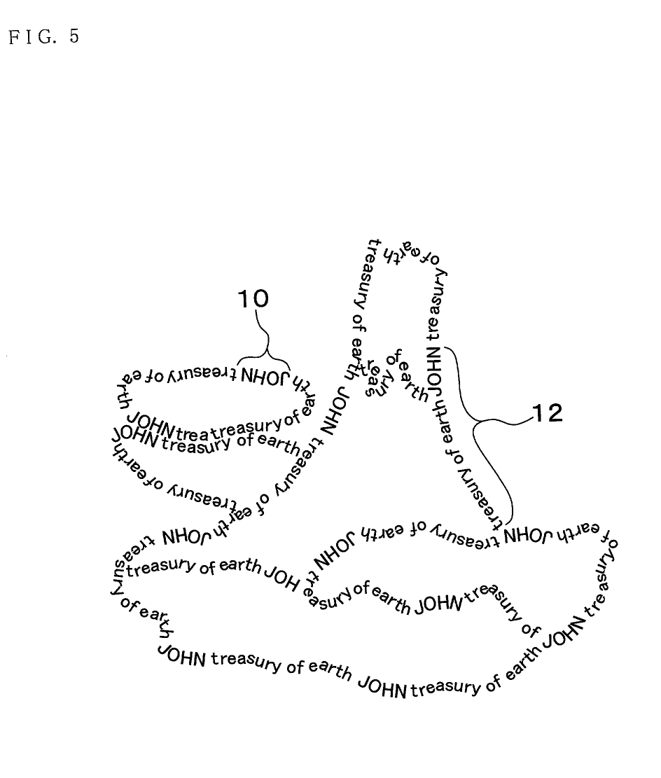

FIG. 5 is an example of graphic matter delivered to the recipient.

It is also possible to convert the graphic matter accompanied with the temporary name stored in the recorder to the graphic matter containing said temporary name as components of this graphic matter and to deliver this to the recipient periodically.

In the example shown in FIG. 5, the recipient's name (10) “JOHN” for its temporary name. The graphically represented mountain is described by a continuous array of characters (12) “treasury of earth JOHN” containing therein the recipient's name.

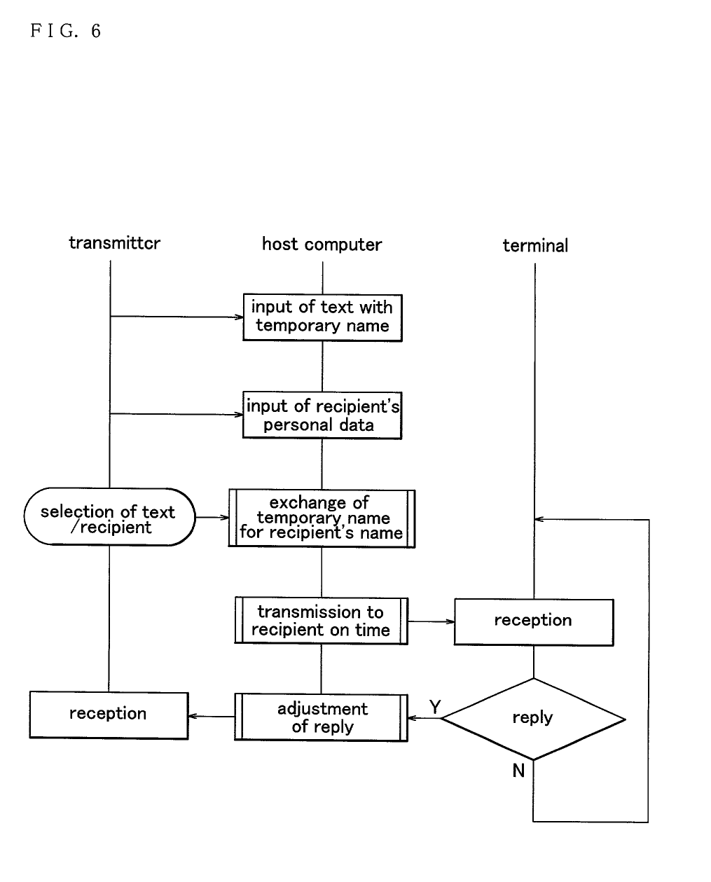

FIG. 6 is a block diagram illustrating important parts of the system according to another embodiment of the present invention.

Transmitter previously inputs a plurality of texts each containing a temporary name and the personal data of the recipient into the host computer.

The text accompanied with a temporary name stored in the host computer is not limited to the text made by the transmitter him- or herself but those previously stored in the recorder may be also used.

The text accompanied with a temporary name may have various contents such as liaison matter for business, educational content according to a predetermined program, psychological content for encouragement and formal content of congratulation or condolence, depending on the particular purpose of transmission.

The personal data of the recipient stored in the host computer includes items such as the recipient's name, mail address, gender, age, various memorial days such as birthday, hobby and taste, occupation, names of company, division, section and post.

These personal data are used by the recipient identifying device in the host computer to classify and identify the recipients.

In response to input of text accompanied with temporary name from a transmitter to the host computer, the recipient identifying device in the latter selects the appropriate recipient for this text and exchanges the recipient's name for said temporary name in said text accompanied with the temporary name.

In this embodiment, it is also possible for the transmitter to select said appropriate recipient and to input this to the host computer. In this case, the recipient identifying device in the host computer takes account of attributes and memorial days contained in the personal data of this recipient to select an appropriate text accompanied with a temporary name and then the name exchanging device in the host computer exchanges the name of this recipient for said temporary name accompanying the text.

It is also possible for the transmitter to select both the text accompanied with the temporary name to be delivered and the recipient and input them to the host computer.

Then the delivering device in the host computer delivers the particular text accompanied with the recipient's name to the mail address of this recipient on the date and hour based on the personal data of this recipient.

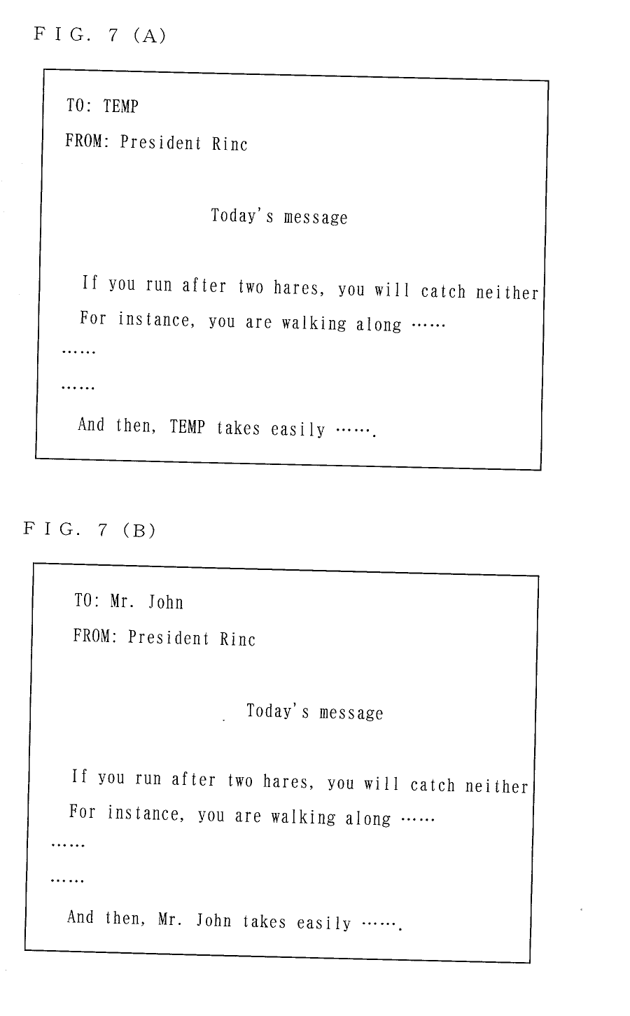

FIG. 7 shows an example of the text delivered in such manner.

Assumed that the transmitter selects a text (30) accompanied with a temporary name as shown in FIG. 7(A) and inputs this to the host computer, the recipient identifying device in the latter determines an appropriate recipient to whom said text (30) accompanied with the temporary name should be delivered. Thereafter, the name exchanging device in the host computer exchanges the recipient's name “JOHN” (10) for the temporary name (TEMP) in said text (30) and the delivering device delivers the text (20) accompanied with the recipient's name as shown in FIG. 7(B) to the mail address of this recipient.

In this case shown in FIG. 7, the transmitter is a company president and the selected text (30) accompanied with the temporary name has a psychological content for encouragement. Accordingly, the host computer selects employees of this company as appropriate recipients and a work commencement time as an appropriate time for delivery.

Depending on the content of the text (30) accompanied with the temporary name, for example, urgent liaison matters for business, acknowledge of reception or reply is required.

In such case, the host computer puts the reply or replies from the recipient(s) in order and transfers it or them to the transmitter.

This situation is true for the case in which the transmitter is a hospital and the recipients are patients having appointment with the hospital. The hospital may transmit acknowledge of appointment to the relevant patients at once on the preceding day of diagnosis. Thereby the hospital can be informed by replies of whether any patient wishes to alter the appointment or not, on one hand, and the patients can be informed of extra closed hospital, if it occurs, on the other hand. Such procedure is applicable to various reservation system for service facilities such as hotel and beauty salon and various traffic facilities.

The time at which the recipient's personal data was received by the recipient identifying device may be recorded together with said personal data to assist the delivery to be made with good timing.

The recipient's personal data may include the date and hour on which the text or the graphic matter is to be received by the recipient so that the delivering device may operate on said date and hour to meet convenience for both the deliverer and the recipient.

Such system is applicable also to sale of goods with a time limit, for example, perishable foods and DM adapted to deliver sales of services which are effective only on particular date and hour, for example, airline ticket.

Based on the recipients' personal data, the name exchanging device may be operatively associated with the recipient identifying device to deliver text or graphic matter which is different for every recipient and for every delivery to achieve a high individuality of the delivery system. Assumed that several thousand messages to be delivered are prepared to accommodate dozens of recipients, data base may be set for each recipient and indices for contents to be delivered may be successively stored in the data base to avoid an anxiety that one and same message might be repeatedly delivered to each recipient.

The graphic matter delivered by the delivery device to the mail address of the recipient may be still image data or moving image data. The text delivered by the delivery device to the main address of the recipient may be character data or voice data, or a combination of them. It is also possible to deliver a combination of graphic matter and text or to deliver moving image together with voice synchronized with said moving image.

Effect of the Invention

The individually delivering system according to the present invention enables a text or a graphicmatter accompanied with a recipient name and having an appropriate content for this recipient to be delivered with good timing. In this way, every recipient is always interested in the content of the delivered text or graphic matter and the delivery can be made without causing any inconvenience for each recipient.

What is claimed is:

1. Individually delivering system in which a terminal of each recipient is connected to a host computer via wireless- or wire-telecommunication network, said system comprising:
a recipient identifying device adapted to identify a recipient on the basis of the recipient's personal data at least including the recipient's mail address and name,
a name exchanging device adapted to exchange the recipient's name for a temporary name accompanying text or graphic matter previously stored in a recorder, and
a delivery device adapted for individually delivering the text or the graphic matter into which the recipient's name has been introduced by said name exchanging device to the recipient's mail address at time or times predetermined by said recipient identifying device.

2. The individually delivering system according to claim 1, wherein the text delivered by the delivery device to the mail address of the recipient comprises voice data.

3. The individually delivering system according to claim 1, wherein the text delivered by the delivery device to the mail address of the recipient comprises moving image data.

4. The individually delivering system according to claim 1, wherein the recipient identifying device records a time at which the recipient's personal data was received together with said personal data and identifies the recipient.

5. The individually delivering system according to claim 1, wherein the text accompanied with the temporary name comprises a serial novel including approximately ten chapters each comprising several hundred characters and successively delivered starting from its chapter one to the recipient once for every day.

6. The individually delivering system according to claim 5, wherein each chapter of the serial novel is added with choices when this chapter is delivered so that the recipient may select a development of the novel in the following chapter and the content of said following chapter may be adjusted depending on the development selected by the recipient.

7. The individually delivering system according to claim 1, wherein the text accompanied with the temporary name stored in the recorder is a metrical composition completed in every delivery and composed of sentences containing respective characters constituting the temporary name and wherein said metrical composition is delivered to the recipient substantially once for every month.

8. The individually delivering system according to claim 1, wherein the graphic matter accompanied with the temporary name stored in the recorder is a graphic matter containing the temporary name as components of this graphic matter and delivered to the recipient substantially once for every month.

9. The individually delivering system according to claim 1, wherein the recipient's personal data including attributes of this recipient and memorial days peculiar to this recipient.

10. The individually delivering system according to claim 1, wherein the text accompanied with the temporary name is a liaison matter for business.

11. The individually delivering system according to claim 1, wherein the text accompanied with the temporary name comprises educational materials edited in accordance with a predetermined program.

12. The individually delivering system according to claim 1, wherein the text accompanied with the temporary name has 17 a psychological content for encouragement.

13. The individually delivering system according to claim 1, wherein the text accompanied with the temporary name has a formal content of congratulation or condolence

14. The individually delivering system according to claim 1, wherein the name exchanging device is operatively associated with the recipient identifying device so that the text or the graphic matter being different for every recipient and for every delivery.

15. The individually delivering system according to claim 1, wherein the recipient's personal data includes date and hour on which the text or the graphic matter should be received by the recipient so that the delivery device may operated on said date and hour.
